(19) United States
(12) Patent Application Publication
(10) Pub. No.: US 2019/0185048 A1
(43) Pub. Date: Jun. 20, 2019

(54) STUB SHAFT

(71) Applicant: Aircraft Gear Corporation, Loves Park, IL (US)

(72) Inventor: Sean M. Carlini, Rockford, IL (US)

(73) Assignee: Aircraft Gear Corporation, Loves Park, IL (US)

(21) Appl. No.: 16/222,191

(22) Filed: Dec. 17, 2018

Related U.S. Application Data
(60) Provisional application No. 62/774,619, filed on Dec. 3, 2018.
(60) Provisional application No. 62/608,473, filed on Dec. 20, 2017.

(51) Int. Cl. B62D 3/06; F16H 25/20; B60K 17/344; B60K 17/35; F16C 3/02

(52) U.S. Cl. CPC B62D 3/06; F16H 25/20; B60K 17/22; B60K 17/35; F16C 3/02; B60K 17/344

(57) ABSTRACT

Apparatus and methods for achieving a high strength bonded joint between a stub connector and a shaft.

### CROSS REFERENCE TO RELATED APPLICATION

This application claims the benefit of priority to U.S. Provisional Patent Application Ser. No. 62/608,473, filed Dec. 20, 2017, and to U.S. Provisional Patent Application Ser. No. 62/774,619, filed Dec. 3, 2018, both of which are incorporated herein by reference.

### FIELD OF THE INVENTION

Various embodiments of the present invention pertain to modular driveline components, including stub adapters configured to be adhered to shafts fabricated from non-metallic materials.

### SUMMARY OF THE INVENTION

Various embodiments of the inventions described herein pertain to methods and apparatus for achieving structural bonds between a shaft and a stub connector of greatly improved strength. In one embodiment, it is particularly useful in bonding a metallic stub connector to a carbon fiber shaft.

During testing, it has been found that the methods and devices disclosed herein can provide an adhesive connection between a carbon fiber shaft and a stub connector in which the application of high torque results in a failure location located in the shaft, and not in the adhesive joint.

In yet other embodiments of the present invention, various embodiments of the present invention pertain to methods for increasing the surface area of a cylindrical component that is to be adhesively bonded to another component. In some embodiments, the methods and apparatus disclosed are particularly useful for achieving a modular powertrain component, such as for a vehicle drivetrain, generator powertrain, aircraft powertrain, or the like, in which a stub connector can be connected to another powertrain component (such as a shaft) of varying lengths.

It will be appreciated that the various apparatus and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

Some of the figures shown herein may include dimensions. Further, some of the figures shown herein may have been created from scaled drawings or from photographs that are scalable. It is understood that such dimensions, or the relative scaling within a figure, are by way of example, and not to be construed as limiting.

FIG. 1 is a photographic representation of a stub and tube assembly according to one embodiment of the present invention.

FIG. 2 is a perspective CAD surface drawing of a stub according to one embodiment of the present invention.

FIG. 3 is a side elevational cutaway view of the apparatus of FIG. 2.

FIG. 4 is a side elevational view of the apparatus of FIG. 2.

FIG. 5 is a photographic representation of a stub according to another embodiment of the present invention.

FIG. 6 is a photographic representation of the apparatus of FIG. 5 incorporated into a partial assembly.

FIG. 7 is a side elevational cutaway view of the apparatus of FIG. 5.

FIG. 8 is an orthogonal end view of the apparatus if FIG. 7.

FIG. 9 is a side elevational view of the apparatus of FIG. 5.

FIG. 10 is a perspective line drawing of the apparatus of FIG. 9.

FIG. 11 is a side elevational view of an apparatus according to another embodiment of the present invention.

FIG. 12 is a side elevational view of an apparatus according to another embodiment of the present invention.

FIG. 13 is a side elevational view of an apparatus according to another embodiment of the present invention.

FIG. 14 is a side elevational view of an apparatus according to another embodiment of the present invention.

### ELEMENT NUMBERING

The following is a list of element numbers and at least one noun used to describe that element. It is understood that none of the embodiments disclosed herein are limited to these nouns, and these element numbers can further include other words that would be understood by a person of ordinary skill reading and reviewing this disclosure in its entirety.

| | |
|---|---|
| 20 | assembly |
| 30 | shaft or tube |
| 32 | injection hole |
| 34 | inspection hole |
| 36 | adhesive |
| 40 | stub |
| 42 | gearbox attachment end |
| 43 | yoke |
| 44 | spline |
| 45 | shoulder |
| 46 | shoulder maximum diameter |
| 47 | tube attachment end |
| 48 | abutment |
| 49 | tube end support diameter |
| 50 | tube attachment surface |
| 51 | cavity |
| 52 | tube middle support diameter |
| 53 | opened end |
| 54 | helical groove |
| 55 | roughening |
| 56 | inner diameter |

### DETAILED DESCRIPTION OF ONE OR MORE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates. At least one embodiment of the present invention will be described and shown, and this application may show and/or describe other embodiments of the present invention, and further permits the reasonable and logical inference of still other embodiments as would be understood by persons of ordinary skill in the art.

It is understood that any reference to “the invention” is a reference to an embodiment of a family of inventions, with no single embodiment including an apparatus, process, or composition that should be included in all embodiments, unless otherwise stated. Further, although there may be discussion with regards to “advantages” provided by some embodiments of the present invention, it is understood that yet other embodiments may not include those same advantages, or may include yet different advantages. Any advantages described herein are not to be construed as limiting to any of the claims. The usage of words indicating preference, such as “preferably,” refers to features and aspects that are present in at least one embodiment, but which are optional for some embodiments, it therefore being understood that use of the word “preferably” implies the term “optional.”

The use of an N-series prefix for an element number (NXX.XX) refers to an element that is the same as the non-prefixed element (XX.XX), except as shown and described. As an example, an element 1020.1 would be the same as element 20.1, except for those different features of element 1020.1 shown and described. Further, common elements and common features of related elements may be drawn in the same manner in different figures, and/or use the same symbology in different figures. As such, it is not necessary to describe the features of 1020.1 and 20.1 that are the same, since these common features are apparent to a person of ordinary skill in the related field of technology. Further, it is understood that the features 1020.1 and 20.1 may be backward compatible, such that a feature (NXX.XX) may include features compatible with other various embodiments (MXX.XX), as would be understood by those of ordinary skill in the art. This description convention also applies to the use of prime (′), double prime (″), and triple prime (′″) suffixed element numbers. Therefore, it is not necessary to describe the features of 20.1, 20.1′, 20.1″, and 20.1′″ that are the same, since these common features are apparent to persons of ordinary skill in the related field of technology.

Although various specific quantities (spatial dimensions, temperatures, pressures, times, force, resistance, current, voltage, concentrations, wavelengths, frequencies, heat transfer coefficients, dimensionless parameters, etc.) may be stated herein, such specific quantities are presented as examples only, and further, unless otherwise explicitly noted, are approximate values, and should be considered as if the word “about” prefaced each quantity. Further, with discussion pertaining to a specific composition of matter, that description is by example only, and does not limit the applicability of other species of that composition, nor does it limit the applicability of other compositions unrelated to the cited composition.

Various references may be made to one or more methods of manufacturing. It is understood that these are by way of example only, and various embodiments of the invention can be fabricated in a wide variety of ways, such as by casting, sintering, sputtering, welding, electrodischarge machining, milling, as examples. Further, various other embodiment may be fabricated by any of the various additive manufacturing methods, some of which are referred to 3-D printing.

This document may use different words to describe the same element number, or to refer to an element number in a specific family of features (NXX.XX). It is understood that such multiple, different words are not intended to provide a redefinition of any language herein. It is understood that such words demonstrate that the particular feature can be considered in various linguistical ways, such ways not necessarily being additive or exclusive.

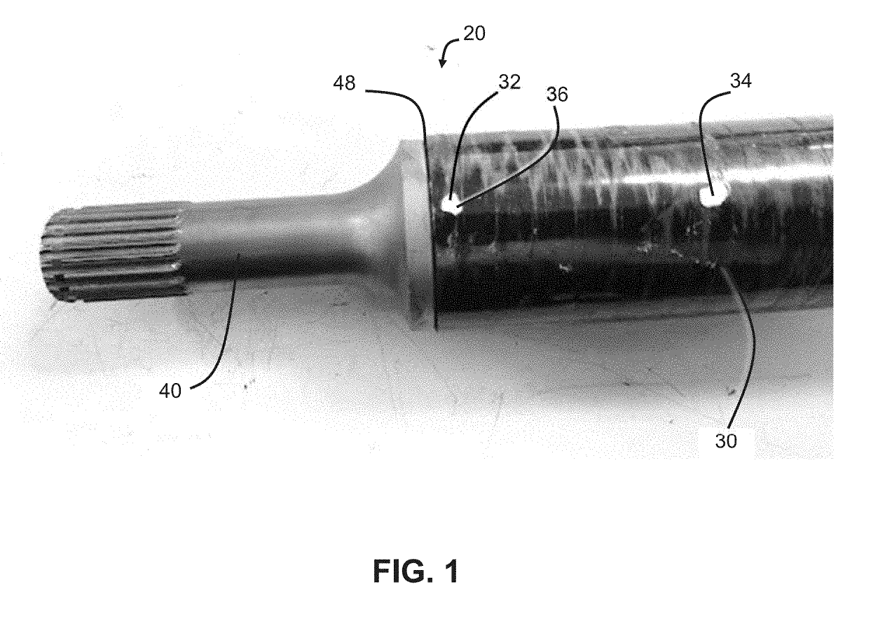

FIG. 1 shows a portion of an apparatus 20 that transmit mechanical power to a device. The apparatus can be used in applications such as vehicle powertrains, industrial machinery power takeoff (PTO) devices of any type, aircraft engine gearboxes, electrical generators, and the like. In some applications, there is a driving unit (such as a transmission of a road vehicle) that provides power, and a receiving unit (such as a rear end differential) that receives the power. In some applications, the apparatus (such as a four wheel drive vehicle) provides power from a power takeoff gearbox to a driven wheel.

The apparatus 20 as shown in FIG. 1 includes a stub 40 that has been adhesively bonded to the inner diameter of a shaft or tube 30. As will be described later, an adhesive 36 has been applied between the stub and the shaft from an injection port 32 to a vent port 34. In one embodiment of the present invention, shaft 30 is a carbon fiber shaft, such as those shafts that include layers or plies of carbon fiber matte that has been wound successively in a variety of directions along the length of the shaft. It is understood that the apparatus 20 of FIG. 1 includes an end of the shaft that is not shown. In some embodiments, the types of stubs X40 shown and described herein are attached to the other end (not shown) of the shaft, although yet other embodiments include any manner of attaching the other end of a shaft to a device, including for example, flanged and bolted joints. Although attachment of the stub to a carbon fiber shaft is shown and described, it is understood that the shaft can be fabricated from any type of material.

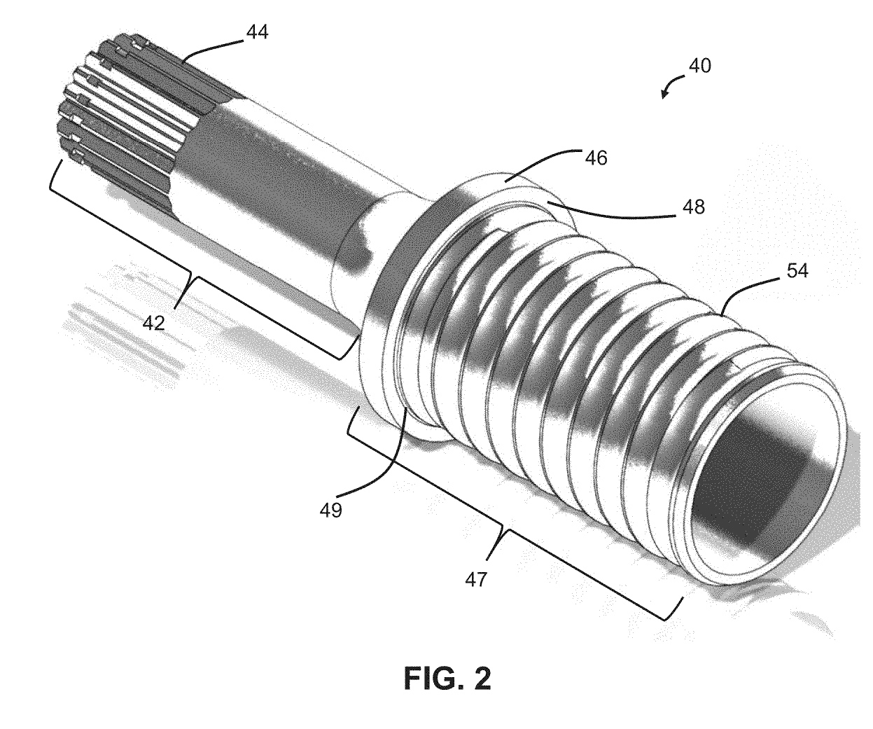

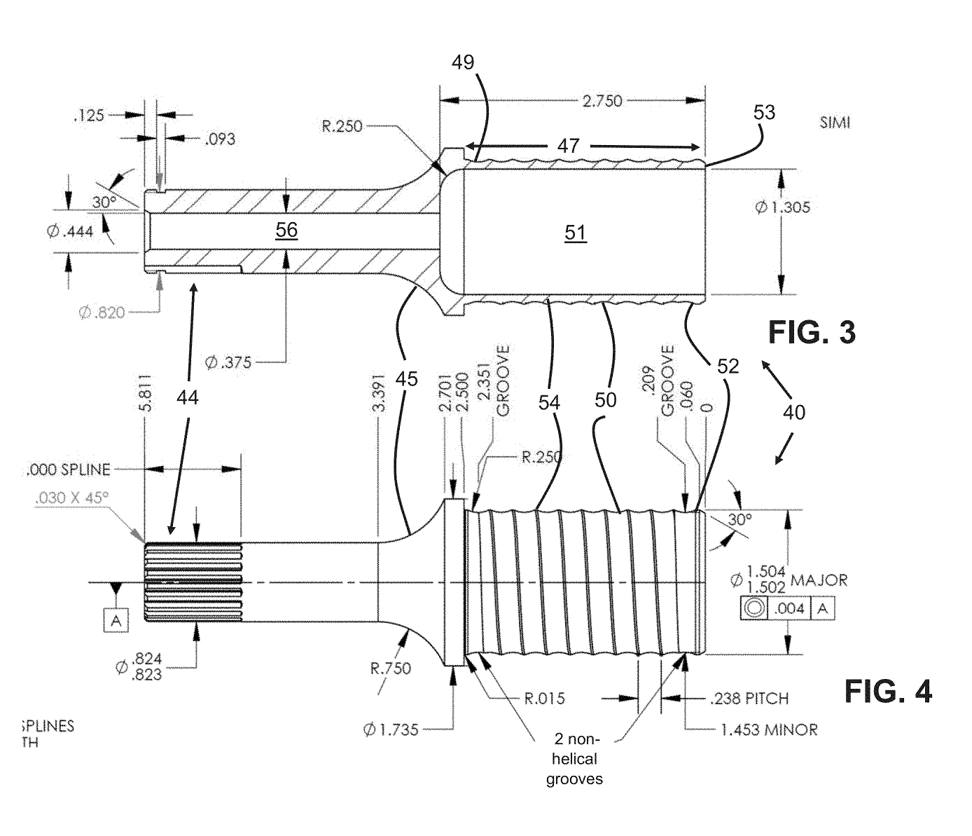

FIGS. 2, 3, and 4 show various views of the stub 40. It can be seen that stub 40 includes a gearbox attachment end 42 and a tube attachment end 47. A curved or rounded shoulder 45 provides a smooth and managed distribution of internal stresses between ends 42 and 47.

The attachment end 42 of stub 40 in some embodiments includes a plurality of splines 44 that generally surround the outer diameter of the attachment end. As is commonly used in vehicle drivetrains, the splines 44 are received within corresponding splines of a drive line component. The linear arrangement of splines permit transmission of torque from apparatus 20 to the driving or driven component, but further allows for changes in the axial distance between the driving and driven devices.

Referring to FIGS. 2, 3, and 4, it can be seen that the tube attachment end 47 is generally cylindrical over its length, with a largely open cavity 51 therein. This cavity 51, as well as inner diameter 56 of gearbox attachment end 42 provide for lighter weight assemblies, and further do not enclose a volume that could otherwise trap air or water.

The tube attachment end 47 extends from one end of stub 40 to an abutment face 48 of the shoulder area 45. The abutment surface extends from the outer surface of the cylindrical attachment end 47 to a maximum diameter 46 of shoulder 45. In some embodiments, the wall of the tube 30, when assembled onto stub 40, will abut against face 48 (as best seen in FIG. 1).

In some embodiments, the tube attachment end 47 includes a tube end support diameter 49 and a tube middle support diameter 52 that are about the same as the inner diameter of tube 30. Therefore, when a tube 30 is placed over tube attachment end 47, there is a relatively tight connection between the inner diameter of the tube and the outer diameters 49 and 52. In some embodiments, this fit can also be an interference fit, such that placement of the tube 30 over attachment end 47 requires axial compression of the assembly. However, in yet other embodiments, the tube 30 and stub 40 in a snug manner.

In some embodiments, attachment end 47 includes an outer surface having one or more helical grooves 54. In the embodiment shown in FIGS. 2, 3, and 4, there is a single helical groove that wraps substantially uninterrupted around the outer diameter of attachment end 47. In some embodiments, the helical groove extends over 8-10 revolutions of the attachment end. However, yet other embodiments include a single groove extending anywhere from more than one revolution to less than about 20 revolutions. Still further, in the figures it can be seen that the helical grooves extend along substantially the entire length of the attachment end 47, with the exception of the supporting diameters 49 and 52. However, it is understood that in yet other embodiments the supporting diameters 49 and 52 can be substantially wider than the pitch of the helical groove (on a relative basis) then as shown in these figures. Still further, the helical groove can extend along only a portion of the attachment end 47, and need not extend to abutment surface 48, or to the open end 53. In still further embodiments, it is understood that the attachment end of the stub need not have both supporting diameters 49 and 52, and can have only one of these diameters.

Referring to FIGS. 1 and 4, assembly of device 20 includes placing the open end of tube 30 over the tube attachment end of stub 40. Preferably, the end of the tube abuts against face 48 of shoulder 45. A suitable adhesive is then inserted into injection hole 32, and adhesive is injected into the interface between the inner diameter of the tube and the outer surface of the tube attachment end of stub 40. Referring to FIG. 4, it is appreciated that in those embodiments in which the maximum diameter of the helical groove is relatively tight against the inner diameter of a shaft, that the adhesive will flow in a generally helical manner from the opened end of the tube 30 to the venting or inspection hole 34. Once the adhesive has reached the vent hole 34, the adhesive filling procedure is stopped, and the assembly can subsequently (after a setting) be inspected. The helical grooves can aid in ensuring that there are no adhesive voids, by providing a sufficiently tight helical flowpath. The flow of adhesive in an axial direction is met with more flow resistance than in the circumferential (helical) direction. It is less likely that the adhesive 36 would flow directly from port 32 to port 34, or flow in a manner that leaves a void at any location along the length of the tube attachment end 47.

The helical grooves 54 of attachment end 47 further increase the total amount of surface area available for adhesion between stub 40 and shaft 30. Referring again to FIG. 4, it can be seen that the helical groove provides additional surface area (relative to a straight, clean single diameter outer surface) as the surface of the tube attachment end includes the various peaks and valleys of the groove 54. In some embodiments, it can be seen that the depth of the helical groove (from peak to valley) is from about two hundredths of an inch to about three hundredths of an inch, although yet other embodiments contemplate a groove depth anywhere from one one hundredth of an inch to about five hundredths of an inch. Still further, as seen in FIG. 4, the helical grooved section extends between two non-helical grooves, one groove proximate to end 53, and the other groove proximate to abutment surface 48.

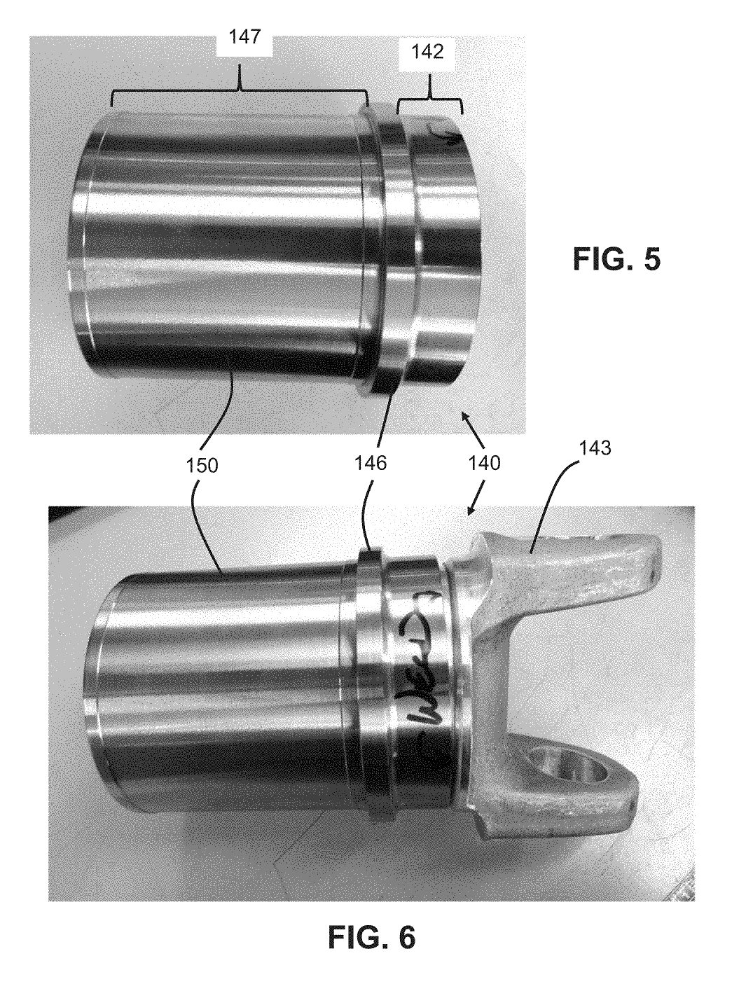

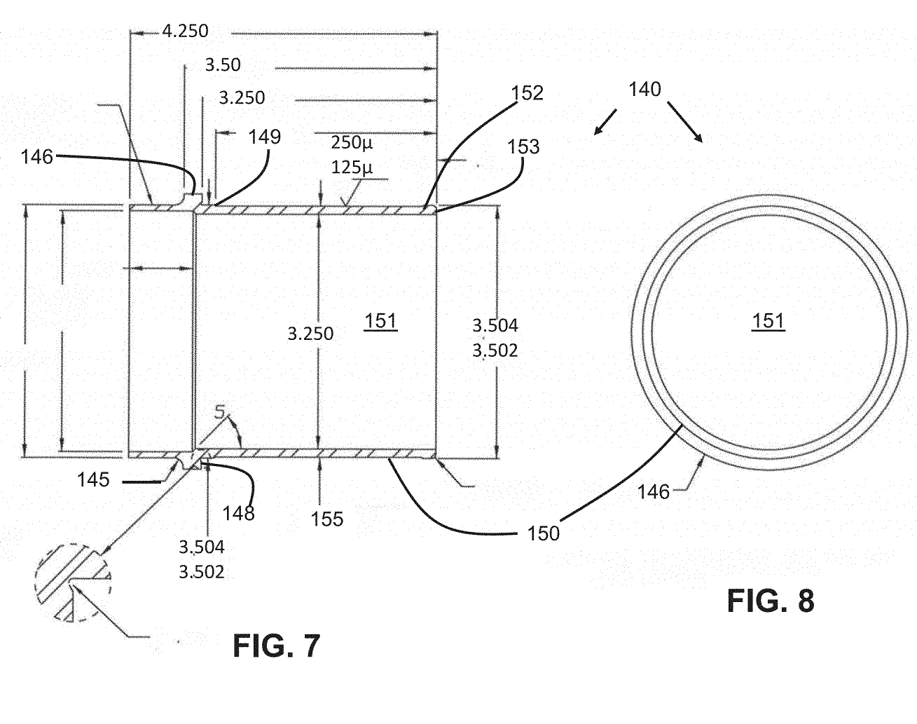

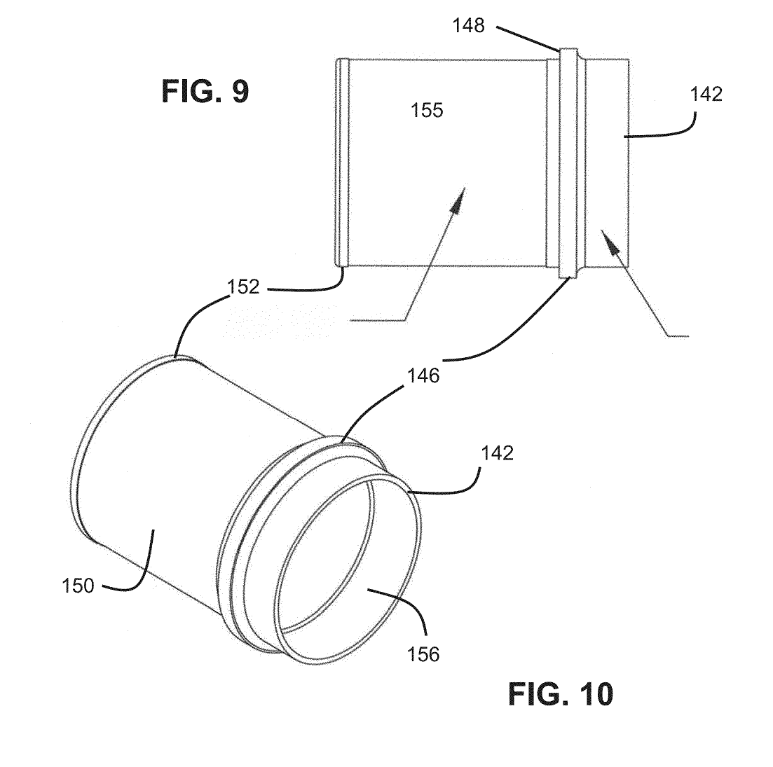

FIGS. 5-10 show a stub 140 according to another embodiment of the present invention. Stub 140 includes many of the same features of stub 40, as will be appreciated by those of ordinary skill in the art.

Stub 140 differs from stub 40 by including a portion of a yoke connection 143 in place of the splines 44. Stub 140 also differs by having a roughed surface 155 over substantially all of the tube attachment surface 150, instead of the helical groove 54. In some embodiments, the roughness of the surface is from about 100 micrometers to 300 micrometers. It has been found that the roughened surface provides additional surface area for bonding of the adhesive.

FIGS. 11-14 show other variations of stub 140. FIG. 11 shows a stub 240 that has a roughened surface 255 over substantially all of the tube attachment surface 250. In some embodiments, the roughness of the surface is from about 100 micrometers to 300 micrometers. It has been found that the roughened surface 255 provides additional surface area for bonding of the adhesive. Further, it is noted that the various designers of carbon fiber shafts that are selecting a stub shaft for attachment may have preference for the roughened surface based on either the method of creating the roughening, or based on the aesthetics of the surface. It is noted that the various methods of roughening shown herein may provide roughly equivalent surface areas for bonding, yet have different aesthetic values. As one example, the roughened surface 255 of FIG. 11 can be achieved by methods such as by way of media blasting of the surface with an abrasive material such as with aluminum oxide, glass beads, or the like.

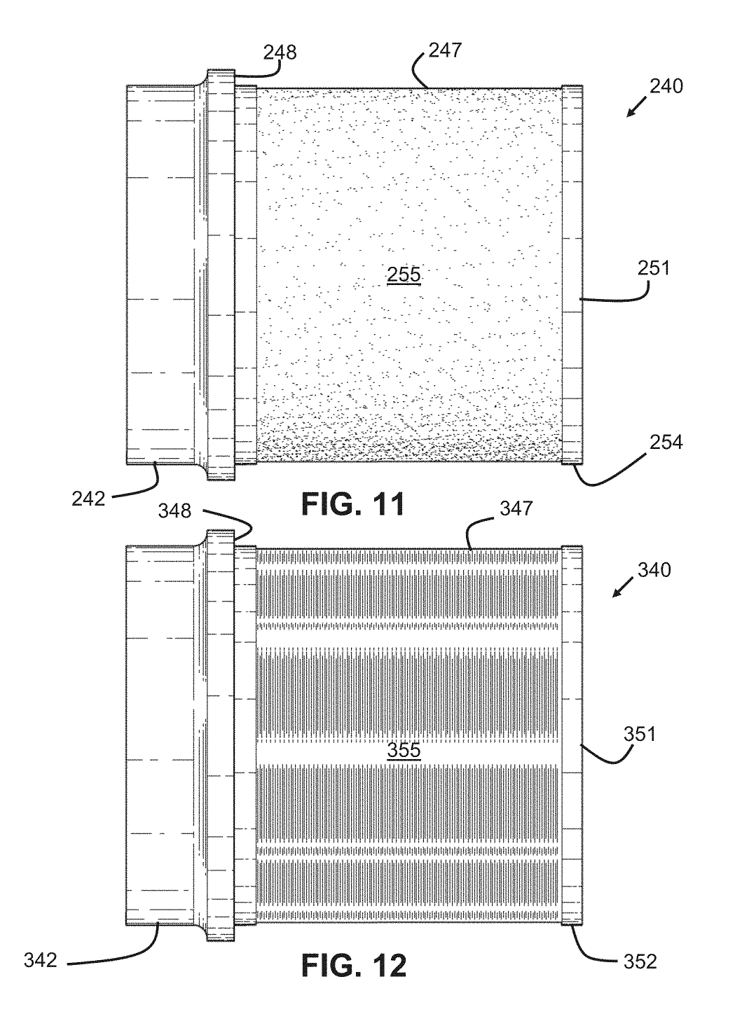

FIG. 12 shows a stub 340 that has a roughened surface 355 over substantially all of the tube attachment surface 350. In some embodiments, the roughness of the surface is from about 100 micrometers to 300 micrometers. It has been found that the roughened surface 355 provides additional surface area for bonding of the adhesive. Further, it is noted that the various designers of carbon fiber shafts that are selecting a stub shaft for attachment may have preference for the roughened surface based on either the method of creating the roughening, or based on the aesthetics of the surface. It is noted that the various methods of roughening shown herein may provide roughly equivalent surface areas for bonding, yet have different aesthetic values. As one example, the roughened surface 355 of FIG. 12 can be achieved by methods such as by rough turning of the surface on a lathe.

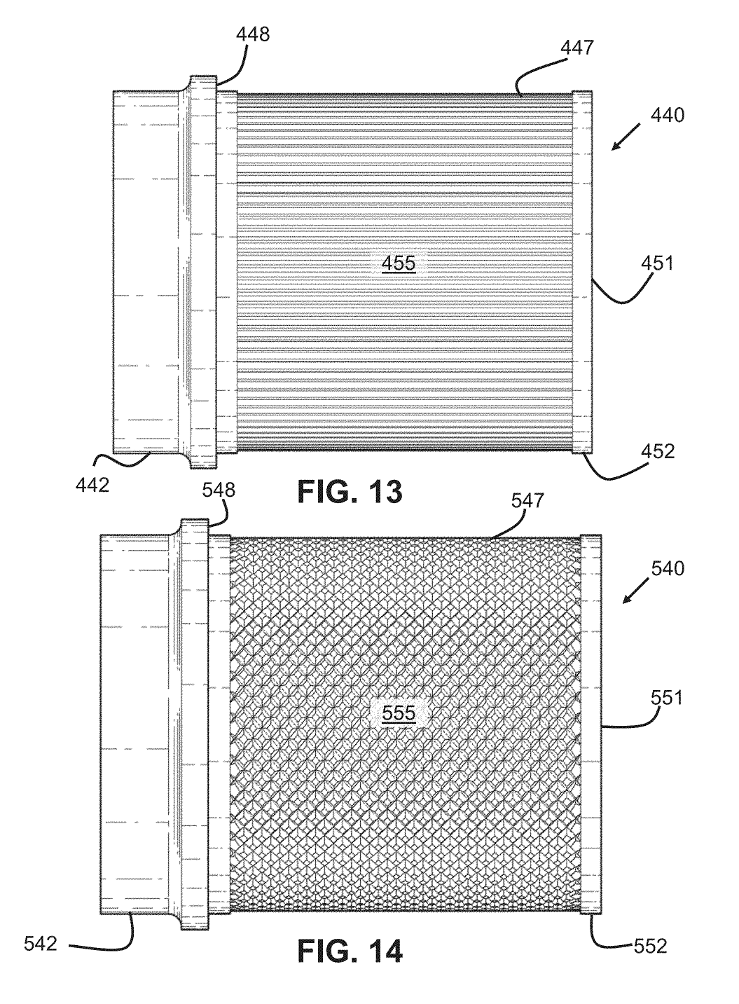

FIG. 13 shows a stub 440 that has a roughened surface 455 over substantially all of the tube attachment surface 450. In some embodiments, the roughness of the surface is from about 100 micrometers to 300 micrometers. It has been found that the roughened surface 455 provides additional surface area for bonding of the adhesive. Further, it is noted that the various designers of carbon fiber shafts that are selecting a stub shaft for attachment may have preference for the roughened surface based on either the method of creating the roughening, or based on the aesthetics of the surface. It is noted that the various methods of roughening shown herein may provide roughly equivalent surface areas for bonding, yet have different aesthetic values. As one example, the roughened surface 455 of FIG. 13 can be achieved by methods such as by knurling the surface with a straight-patterned tool, although it is also recognized that an angular pattern (in which the knurled lines are no longer parallel to the centerline) could be placed on the surface.

FIG. 14 shows a stub 540 that has a roughened surface 555 over substantially all of the tub attachment surface 550. In some embodiments, the roughness of the surface is from about 100 micrometers to 300 micrometers. It has been found that the roughened surface 555 provides additional surface area for bonding of the adhesive. Further, it is noted that the various designers of carbon fiber shafts that are selecting a stub shaft for attachment may have preference for the roughened surface based on either the method of creating the roughening, or based on the aesthetics of the surface. It is noted that the various methods of roughening shown herein may provide roughly equivalent surface areas for bonding, yet have different aesthetic values. As one example, the roughened surface 555 of FIG. 14 can be achieved by methods such as by knurling the surface with a diamond-patterned tool. It is further recognized that the knurling options are not limited to straight, angulated, or diamond patterns, and can include any pattern that provides roughness within the suitable range.

Various embodiments of the present invention introduce carbon fiber (CF) tube propeller shafts to traditional driveline shops for application in various vehicles including off-road vehicles. Only a few driveline shops have adopted the carbon fiber technology. Beyond having an ample supply of CF tubing, another obstacle is having ends to affix to the tubing to make a complete CF assembly. The traditional technology consists of steel tubing and steel yokes that are welded together. The CF tubing requires quite different ends that have a large area that is bonded to the tubing using structural adhesive. The proposed adapter allows a shop to weld any of their current tubing ends to the adapter and then bond the welded assembly to the CF tube.

In some embodiments, the conventional tubing end is pressed into and welded to the stub. The weldment can then be bonded to the carbon fiber tube. So rather than a driveline shop having to purchase and stock a complete line of bondable yokes, a stub or adapter according to some embodiments allows the conversion of any conventional driveline component to be bondable.

The stub has a helical glue path that both centers the stub in the carbon fiber tubing and provides a method to insure complete adhesive fill when assembling. The profile of the stub provides more surface area available for bonding than the other designs, and the helical nature would tend to tighten the stub against the end of the tube that is inserted in.

The adhesive ports are 0.125 holes through the tubing that intersect the start and end of the helix. As far as the angle both ports are preferably at zero degrees relative to one another spaced along the axis of the tube. The raised diameters center the adapter and provide a slight press fit to retain the adapter and seal off the adhesive. The roughed reduced center section allows for the optimal bond thickness. Stubs in some embodiments are fabricated from steel or aluminum (for an appropriate interface with aluminum driveline components).

Various aspects of different embodiments of the present invention are expressed in paragraphs X as follows:

X. On aspect of the present invention pertains to an apparatus for transmitting mechanical power to a device. The apparatus preferably includes a shaft having a shaft length, an outer diametral surface, an inner diametral surface, and two ends, at least one end being open, the shaft including an adhesive injection port located proximate to the open end. The apparatus preferably includes a stub adapted and configured for adhesive connection to said shaft, said stub having a first end adapted and configured to fit within the opened end of said shaft and a second end adapted and configured for connection to the device, one of the inner surface of the first end or the outer surface of the first end including means for increasing the surface area available for adhesion; wherein one of the inner diametral surface of the open end of the shaft is placed over the outer diametral surface of the first end of said stub and an adhesive material is placed in the gap between the outer surface of the first end and the inner diametral surface of the opened end of the shaft. The apparatus preferably includes the outer diametral surface of the open end of the shaft is placed within the inner diametral surface of the first end of said stub and an adhesive material is placed in the gap between the inner surface of the first end and the outer diametral surface of the opened end of the shaft.

Yet other embodiments pertain to the previous statement X, which is combined with one or more of the following other aspects. It is also understood that the aforementioned X paragraph includes listings of individual features that can be combined with individual features of other X paragraphs.

Wherein said means for increasing the surface provides a surface having a surface roughness greater than about 100 microns.

Wherein said means for increasing the surface provides a surface having a surface roughness greater than about 100 microns and less than about 400 microns.

Wherein said means for increasing the surface area include a surface roughened by media blasting.

Wherein said means for increasing the surface area include a surface roughened by knurling a pattern.

Wherein said means for increasing the surface area include a surface roughened by turning on a lathe.

Wherein the first end has a length that is greater than the inner diameter.

Wherein the surface including means for increasing the surface area is the inner surface of the first end.

Wherein the surface including means for increasing the surface area is the outer surface of the first end.

Wherein said shaft includes a venting port located intermediate of the two ends.

Wherein the injection port and the venting port are generally in axial alignment.

Wherein the injection port and the venting port are visible and accessible from the same longitudinal side of the first end.

Wherein each of the first end of said stub and the second end of said stub include diametral surfaces that are adapted and configured to be in corresponding interference fits with the inner diameter of said shaft.

Wherein the stub includes a non-helical groove proximate to the second end.

Wherein said stub includes a shoulder having a surface adapted and configured to abut against the open end of said shaft.

Wherein the shaft is fabricated from carbon fibers.

Wherein the second end of said stub includes splines.

Wherein the second end of said stub includes a yoke connection, and the yoke connection is welded to said stub.

Wherein the adhesive substantially fills gap

Wherein said means for increasing the surface includes a helical groove that extends more than once around the surface of the first end, the groove having a surface roughness greater than about 50 microns.

Wherein the device is a driveline component of a vehicle, and the helical groove is oriented to tighten said shaft to said stub when the vehicle is powered in the forward direction.

Wherein said means for increasing the surface includes a helical groove that extends more than once around the surface of the first end

Wherein the first end has a length, and the ratio of the length in inches divided by the number of complete revolutions of the helical groove is less than about 0.7 and more than about 0.1.

Wherein the helical groove is adapted and configured to provide less resistance to flow of adhesive material in the helical direction than in the axial direction.

Wherein the maximum diameter of the helical groove is adapted and configured to fit closely to the inner diametral surface of said shaft.

Wherein the maximum diameter of the helical groove is adapted and configured to fit in interference with the inner diametral surface of said shaft.

Wherein the depth of the helical groove from peak to valley is less than about five hundredths of an inch and greater than about one hundredth of an inch.

While the inventions have been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

What is claimed is:

1. An apparatus for transmitting mechanical power to a device, comprising:
a shaft having a shaft length, an outer diametral surface, an inner diametral surface, and two ends, at least one end being open, the shaft including an adhesive injection port located proximate to the open end;
a stub adapted and configured for adhesive connection to said shaft, said stub having a first end adapted and configured to fit within the opened end of said shaft and a second end adapted and configured for connection to the device, the outer surface of the first end including means for increasing the surface area available for adhesion;
wherein the open end of the shaft is placed over the first end of said stub and an adhesive material is placed in the gap between the outer surface of the first end of said stub and the inner diametral surface of said shaft.

2. The apparatus of claim 1 wherein said means for increasing the surface provides a surface having a surface roughness greater than about one hundred microns.

3. The apparatus of claim 1 wherein said means for increasing the surface provides a surface having a surface roughness greater than about one hundred microns and less than about four hundred microns.

4. The apparatus of claim 3 wherein said means for increasing the surface area include a surface roughened by media blasting.

5. The apparatus of claim 3 wherein said means for increasing the surface area include a surface roughened by knurling a pattern.

6. The apparatus of claim 3 wherein said means for increasing the surface area include a surface roughened by turning on a lathe.

7. The apparatus of claim 1 wherein the first end of said stub has a length that is greater than the inner diameter of said shaft.

8. The apparatus of claim 1 wherein said shaft includes a venting port located intermediate of the two ends.

9. The apparatus of claim 8 wherein the injection port and the venting port are generally in axial alignment.

10. The apparatus of claim 8 wherein the injection port and the venting port are visible and accessible from the same longitudinal side of the first end.

11. The apparatus of claim 1 wherein each of the first end of said stub and the second end of said stub include outer diametral surfaces that are adapted and configured to be in a corresponding interference fit with the inner diameter of said shaft.

12. The apparatus of claim 1 wherein the stub includes a non-helical groove proximate to the second end.

13. The apparatus of claim 1 wherein said stub includes a shoulder having a surface adapted and configured to abut against the open end of said shaft.

14. The apparatus of claim 13 wherein the shaft is fabricated from carbon fibers.

15. The apparatus of claim 14 wherein the second end of said stub includes splines.

16. The apparatus of claim 15 wherein the second end of said stub includes a yoke connection, and the yoke connection is welded to said stub.

17. The apparatus of claim 16 wherein the adhesive substantially fills gap

18. The apparatus of claim 1 wherein said means for increasing the surface includes a helical groove that extends more than once around the surface of the first end, the groove having a surface roughness greater than about 50 microns.

19. The apparatus of claim 18 wherein the device is a driveline component of a vehicle, and the helical groove is oriented to tighten said shaft to said stub when the vehicle is powered in the forward direction.

20. The apparatus of claim 1 wherein said means for increasing the surface includes a helical groove that extends more than once around the surface of the first end.

21. The apparatus of claim 20 wherein the first end has a length, and the ratio of the length in inches divided by the number of complete revolutions of the helical groove is less than about seven-tenths and more than about one-tenth.

22. The apparatus of claim 21 wherein the helical groove is adapted and configured to provide less resistance to flow of adhesive material in the helical direction than in the axial direction.

23. The apparatus of claim 20 wherein the maximum diameter of the helical groove is adapted and configured to fit closely to the inner diametral surface of said shaft.

24. The apparatus of claim 23 wherein the maximum diameter of the helical groove is adapted and configured to fit in interference with the inner diametral surface of said shaft.

25. The apparatus of claim 20 wherein the depth of the helical groove from peak to valley is less than about five hundredths of an inch and greater than about one hundredth of an inch.
